(19) United States
(12) Patent Application Publication
(10) Pub. No.: US 2009/0310947 A1
(43) Pub. Date: Dec. 17, 2009

(54) Apparatus and Method for Processing and Blending Multiple Heterogeneous Video Sources for Video Output

(75) Inventor: Cedric Chillie, Mougins (FR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SCALEO CHIP, Valbonne (FR)

(21) Appl. No.: 12/140,757

(22) Filed: Jun. 17, 2008

(51) Int. Cl. H04N 7/01

(52) U.S. Cl. 386/131

(57) ABSTRACT

Apparatus and methods for video processing that integrate multiple processing modules that execute methods for simultaneous format conversion, scaling and image blending from a plurality of video sources, resulting in a video output ready for display. The modules use methods that are optimized for integration in pipeline architecture, enabling the processor to increase the number of video input sources while minimizing access to external memory. The processor combines multiple such pipelines, enabling the processor to simultaneously process a plurality of video inputs and combine these inputs into a single video output. The architecture is implemented as a hardware video processing apparatus.

### BACKGROUND OF THE INVENTION

1. Field of the Invention

The present invention relates generally to the simultaneous processing of a plurality of video inputs provided in different image and video formats, and compositing these inputs to a single composite output subject to blending parameters and scaling.

2. Prior Art

The display of multiple sources of video and computer graphics in real-time as a composite picture is required in applications ranging from consumer video devices, such as Set-Top-Boxes and DVD players, to embedded automotive displays. In the alpha blending method of compositing images, described by Porter and Duff in “Compositing Digital Images” (Computer Graphics, pp. 253-259, vol. 18 no. 3, July 1984), a foreground image F, described as a vector of Red, Green and Blue pixels, is combined with a Background image B with a predefined alpha channel α describing the extent of foreground coverage of the background, or the extent of opacity of the foreground pixels. This method of blending may be implemented using a general CPU and frame buffer memory is shown in U.S. Pat. No. 5,651,107. The blending computation requires multiplication of the pixel Red, Green and Blue values of the foreground image with the α value for each pixel, and summing with the product of the expression (1-α) with the Red, Green and Blue pixel values of the background image. This requires integer and floating point multiplication, which is a costly operation for a general purpose CPU (“Compositing, Part 2: Practice”, IEEE Computer Graphics and Applications, pp. 78-82, vol. 14, no. 6, November 1994).

Graphics processors with instructions for these operations can efficiently perform alpha blending. Processors capable of vector processing are able to process the alpha blending of a set of pixels of the foreground, background together with the alpha channel in parallel, as shown in U.S. Pat. Nos. 5,767,867 and 7,034,849. Color images are more efficiently represented using a Color Lookup Table (CLUT) than by pure RGB. Alpha blending of CLUT images requires generation of the blended CLUT, and mapping the output image to the blended CLUT, as shown in U.S. Pat. No. 5,831,604. Images being blended may require scaling and resolution conversion to an output resolution and format, followed by blending in the resolution and representation [α,RGB or α, CLUT] as shown in U.S. Pat. No. 5,914,725.

Consumer applications require blending of multiple images and video to a single output image, with each input source potentially having a format different than the output format. The multiple image and video sources can be treated as different image layers, each converted to a common output format and blended with a background for output. Each layer is then blended into the other layers to produce the output layer as shown in U.S. Pat. No. 6,157,415. The hardware implementation of Alpha Blending is feasible through the combination of multiplier and adder circuits as shown in European Patent Application Publication No. 0588522.

Graphics chips have implemented the compositing of multiple graphics layers with video input, including format conversion from YUV format to RGB format and video scaling. Such chips use a memory controller to access the graphics images and video frame buffer in memory, and combine the graphics layers sequentially in a graphics pipeline based on the alpha values using a graphics blending module using line buffers, and then combine the blended graphics image with the video input using a video compositor module as shown in U.S. Pat. Nos. 6,570,579, 6,608,630 and 6,700,588. Recent advances in semiconductor technology have made the integration of multiple pipelines for graphics and video compositing feasible as shown, for example, in U.S. Patent Application Publication No. 2007/0252912. However, while format conversion and scaling of the layers may be done in parallel, Alpha Blending necessitates sequential processing of the image layers, typically specifying a rendering order from background to highest foreground.

Methods for image format conversion from YUV to RGB are well known. The YUV format is a common format for video, providing lossy compression with preservation of video quality. The conversion of YUV to RGB uses a sequence of interpolation and standard conversion steps as described by Poyton in “Merging computing with studio video: Converting between R′G′B′ and 4:2:2″, 2004, http://www.poynton.com/papers/Discreet_Logic/index.html and further in U.S. Pat. Nos. 5,124,688 and 5,784,050. Conversion between the YUV formats from YUV4:2:0 and upsampling to YUV 4:2:2 and YUV 4:4:4 has been implemented in hardware circuits as shown in U.S. Pat. No. 6,674,479.

Current and future applications for compositing multiple sources of video and graphics into high resolution video output will require the blending of an increasing number of input sources, at increasing resolution, such as HDTV. As these factors increase, memory access and bus bandwidth for the input sources and for frame buffer memory become critical resources. Hence, it would be advantageous to provide a solution that overcomes the limitations of the prior art.

### BRIEF DESCRIPTION OF THE DRAWINGS

FIG. 1 is a block diagram of a system-on-a-chip, according to a preferred embodiment of the invention.

FIG. 2 is a detailed block diagram of the system of FIG. 1.

FIG. 3 is a schematic diagram showing the conversion/scaling chain.

FIG. 4 is a block diagram of the conversion module.

FIG. 5 is a block diagram of the YUV to RGB conversion chain.

FIG. 6 is a block diagram of the video module.

FIG. 7 is a schematic diagram of the alpha blending of multiple image layers and the rendering order in blending.

FIG. 8 is a schematic diagram showing alpha blending of two layers with a global alpha coefficient.

FIG. 9 is a schematic diagram showing the implementation of alpha blending by the mixer unit chains in the pixel management module.

FIG. 10 is a schematic diagram showing the implementation of mixer module for alpha blending.

### DETAILED DESCRIPTION OF THE PREFERRED EMBODIMENTS

Apparatus and methods for video processing that integrate multiple processing modules that execute methods for simultaneous format conversion, scaling and image blending from a plurality of video sources, resulting in a video output ready for display. The modules use methods that are optimized for integration in a pipeline architecture, enabling the processor to increase the number of video input sources while minimizing required access to external memory. The processor combines multiple such pipelines, enabling the processor to simultaneously process a plurality of video inputs and combine these inputs into a single video output. This architecture is implemented as a hardware video processing apparatus.

Graphics controllers for many applications must receive input streams of images and video in different formats, and composite these inputs to a single output video stream. The throughput of such controllers may be limited by the system memory bus access overhead of the image and video processing. Accordingly, the preferred embodiment of the present invention is a system-on-chip (SoC) architecture consisting of a plurality of processing pipelines, driven by the output module. This architecture and pipeline-based methods greatly reduce the memory bus access, increasing throughput and scalability in the number and resolution of the video inputs.

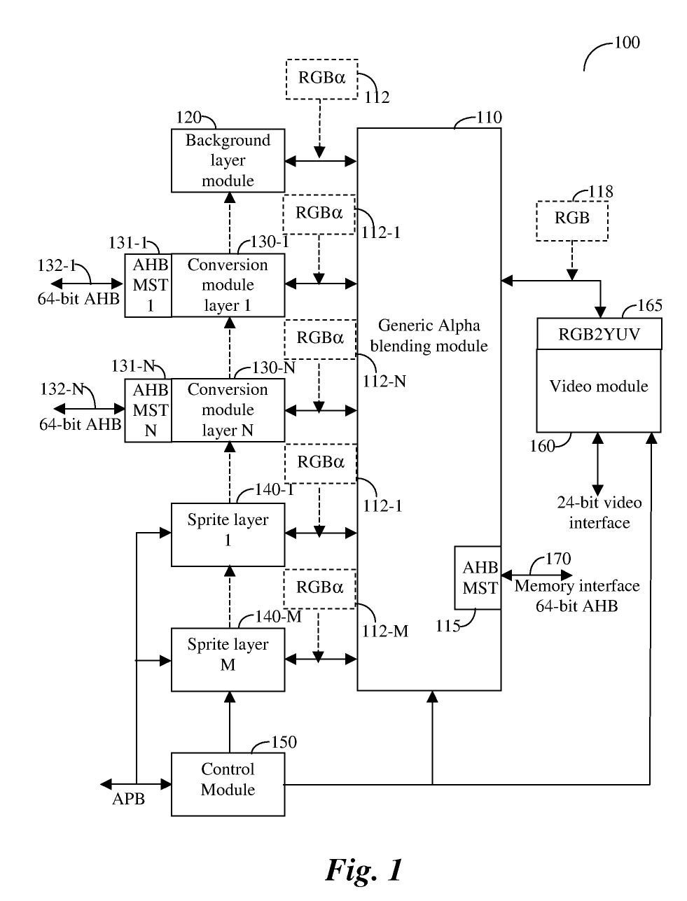

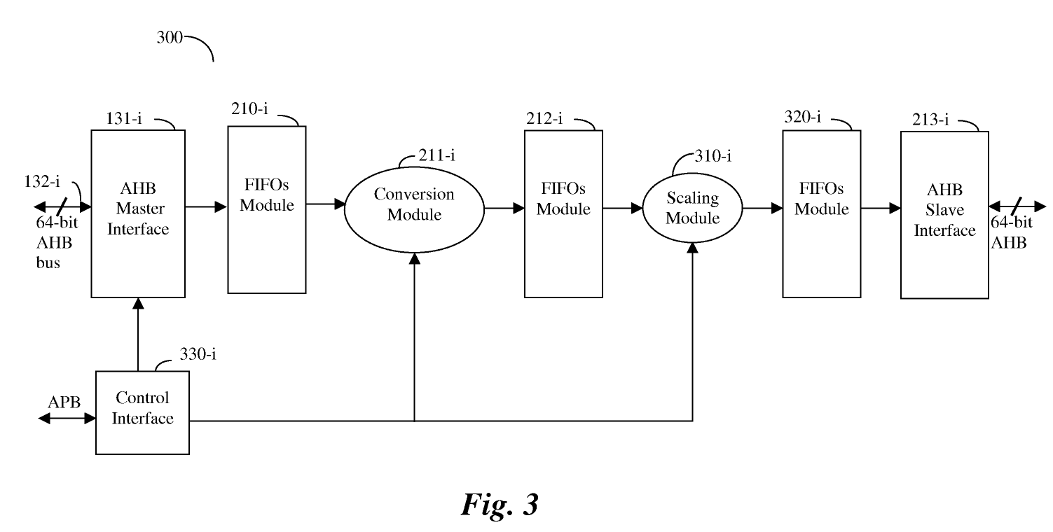

Reference is now made to FIG. 1 where an exemplary and non-limiting block diagram of the system architecture 100 is shown. An exemplary and non-limiting embodiment of this architecture is as a system-on-chip implemented on a monolithic semiconductor. This diagram shows the system 100 which is capable of receiving a plurality of input streams in parallel, received over memory busses 132-1 through 132-N. Such busses 132 may be implemented as an advanced hardware bus (AHB). Each stream may consist of image or video data, received in one of a plurality of formats. These formats include, but are not limited to, 32-bit RGBA, 24-bit RGB, 16-bit RGB565, RGB555-alpha, 24-bit YUV, YUV4:4:4, YUV4:2:2 and YUV 4:2:0 video, provided as progressive or interlaced streams. These streams are accessed through the bus mastering interfaces for each stream, 132-1 to 132-N. Each stream is then processed by a conversion module 130, 130-1 to 130-N. The conversion modules 130 perform format conversion on the input stream, from the input format to RGB alpha as shown by 112-1 and 112-N. The background layer module 120 provides a single color RGB alpha background layer 112, eliminating the need for access to system memory for background layer specification. In an alternate embodiment, the system 100 provides scaling modules (not shown here, but shown with respect to FIG. 3 and explained in more detail with respect thereto below) as part of the pipeline following the format conversion. The scaling modules convert the size and resolution of the input video images to the desired output size and resolution.

The sprite layer modules 140-1 to 140-M provide the input of small graphical objects, for example, without limitation, a mouse cursor, converting these objects to RGB alpha format 112-1 and 112-M. The modules 140 are directly accessible through the advanced peripheral bus (APB) and uses internal memory to store the sprite data. The control module 150 controls: the conversion modules 130 for the input layers, the sprite modules 140, the generic blending module (GBM) 110 as well as the video module 165.

The converted input video layers are blended following conversion to RGB alpha format by the generic blending module 110. The resulting blended composite video layer is output as RGB 118 and provided to the video module 160. The video module 160 provides output video data in the required format, e.g., YUV or RGB, and with the appropriate horizontal and vertical synchronization. The video can be converted by a RGB2YUV module 165. The video output can also be provided to memory over a bus interface 170, using for example an AHB master 115.

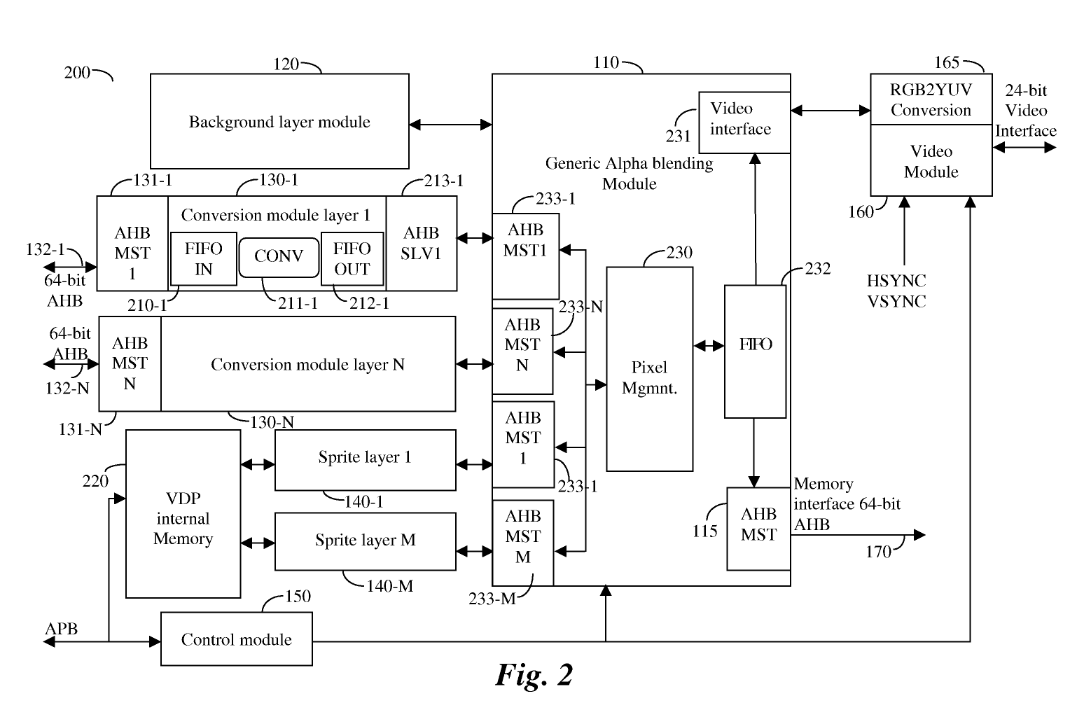

Reference is now made to FIG. 2, which shows a detailed block diagram 200 of the system. In this diagram, the flow of image and video data in the system is driven from the video or memory output side, through a series of bus interfaces and FIFOs (first in first out storage). The FIFO usage allows to have only read access in memory and consequently there is no write access to memory, and no use of system memory for storage of converted or scaled layers.

The Video Module 160 requests the video layer in RGB from the Video Interface 231, which requests data from FIFO 232. The FIFO requests composited video from the Pixel Management unit 230. The Pixel Management unit processes the Alpha Blending for the plurality of layers in parallel, and requests a plurality of converted video layers via bus master (AHB MST) interfaces for each of the plurality of conversion modules and sprite layers. The parallel data flow though the plurality of conversion modules 130-1 to 130-N is shown for a typical conversion module layer 130-1. The conversion module provides converted video data in RGB alpha to the Generic Alpha Blending unit through the bus slave AHB SLV1 213-1. The converted data is provided from the FIFO OUT 212-1. FIFO OUT 212-1 requests the converted video layer from the CONV module 211-1, the CONV module requests the video layer from FIFO IN 210-1, which is interfaced to the video source memory through AHB MST 1 131-1. The conversion modules 130 are managed by the control module 150, and sprite data and other parameters are stored internal memory 220.

Reference is now made to FIG. 3 where an exemplary and non-limiting schematic diagram 300 of a conversion/scaling chain for a typical i^{th} video layer of the plurality of video layers is shown. In this chain, converted video data is provided to the AHB SLV interface 213-i from the post-scaling FIFO module 320-i. The FIFO-module 320-i requests the scaled video layer from the Scaling module 310-i. The Scaling Module 310-i requests the converted video layer data from FIFO OUT 212-i. The scaling operation for each layer is determined through a set of register values, which specify the horizontal and vertical resolution to be used for each layer in the compositing operation. The FIFO OUT 212-i requests the converted video layer from the Conversion module CONV 211-i. The conversion module 211-i requests the video layer source from FIFO IN 210-i. The FIFO IN 210-i requests the video layer source from the source memory via bus interface AHB MST 131-i.

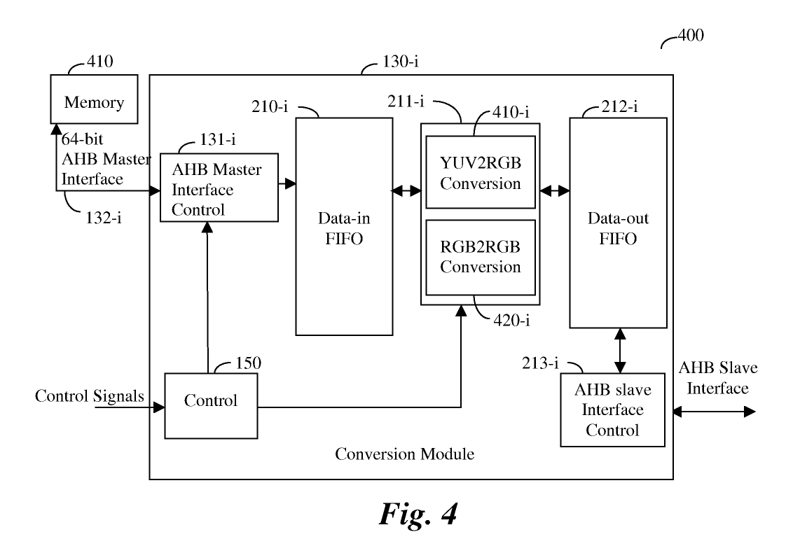

Reference is now made to FIG. 4 which shows an exemplary and non-limiting block diagram 400 of a conversion module 130-i. This drawing shows the CONV module 211-i, which implements the conversion algorithms for YUV to RGB using module YUV2RGB 410-i and RGB formats using module RGB2RGB 420-i. The CONV module receives the input video layer data in source format from FIFO IN 210-i, which receives the source video layer from memory 410 via the bus master interface 131-i over bus 132-i. The CONV module produces a format converted video layer in RGB alpha format to FIFO OUT 212-i, which interfaces to the bus slave interface 213-i.

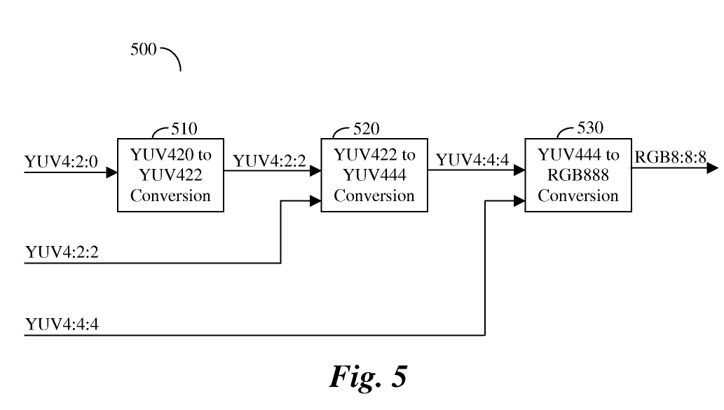

Reference is now made to FIG. 5, which shows an exemplary and non-limiting schematic diagram 500 of a YUV to RGB conversion chain as implemented in the YUV2RGB unit 410-i in the CONV module 211-i. This chain receives the source video layer in a source YUV format, and outputs the video layer in RGB alpha format. The conversion chain converts YUV 4:2:0 to YUV 4:2:2 to YUV 4:4:4 to RGB 8:8:8. The RGB output is combined with the alpha coefficient to produce RGB alpha output. When the video input format is different from RGB-alpha, the alpha coefficient applied for each pixel of the layer is the same, and this coefficient is software programmable.

The YUV 4:2:0 to YUV 4:2:2 conversion 510 consists of the duplication of the chrominance pixels. In YUV4:2:0 video format, chrominance pixels U and V are shared by 4 luminance Y pixels; whereas in YUV4:2:2 video format, chrominance pixels U and V are only shared by 2 Y luminance pixels. The YUV 4:2:2 to YUV 4:4:4 conversion 520 consists of interpolating 2 chrominance U and V pixels to create the “mixing” chrominance U and V pixel. The YUV 4:4:4 to RGB 8:8:8 conversion 530 is performed using well-known conversion equations. An exemplary and non-limiting conversion equation is given as follows:

R=Y+351/256(V−128)=Y+1.371(V−128)

G=Y−179*(V−128)/256−86*(U−128)/256=Y−0.699*(V−128)−0.336*(U−128)

B=Y+443*(U−128)/256=Y+1.73*(U−128)

The coefficients used by the YUV2RGB unit 410-i can be configured through the control module 150.

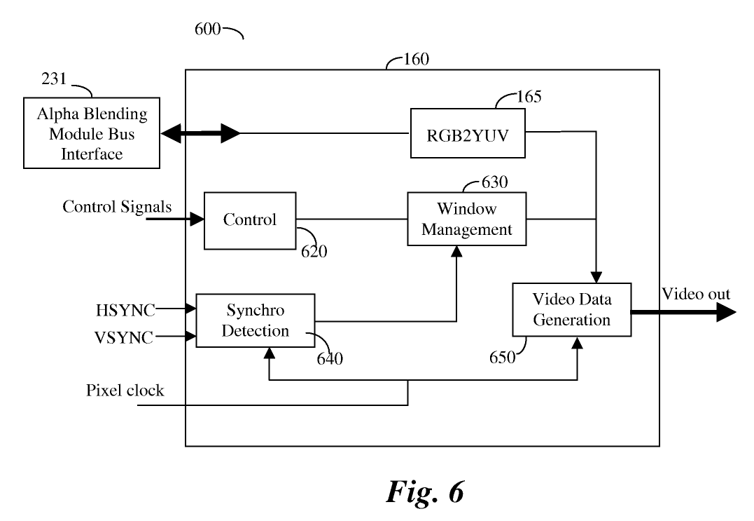

Reference is now made to FIG. 6 which shows an exemplary and non-limiting block diagram 600 of the video module 160. The video module 160 is responsible for the display of the blended video layer on a display, and synchronizes both the display for proper video output and drives the layer conversion/blending pipelines. The video module 160 integrates both the video synchronization signals and the pixel clock. The video module 160 receives blended video in RGB format from the Alpha blending module bus interface 231. The blended video may be converted to YUV format or output in RGB format. RGB to YUV conversion is performed by the RGB2YUV unit 165.

The following equations are used to perform standard definition conversion:

Y=(77*R+150*G+29*B)/256=0.301*R+0.586*G+0.113*B

Cb=(−43*R−85*G+128*B)/256+128=−0.168*R−0.332*G+0.5*B+128

Cr=(128*R−107*G−21*B)/256+128=0.5*R−0.418*G−0.082*B+128

The following equations are used to perform high definition conversion:

Y=(47*R+157*G+16*B)/256+16=0.184*R+0.613*G+0.063*B+16

Cb=(−26*R−87*G+112*B)/256+128=−0.101*R−0.34*G+0.438+128

Cr=(112*R−102*G−10*B)/256+128=0.438*R−0.398*G−0.039+128

The blended video input may also be passed directly as RGB to the video data generation module 650, without intervention by the RGB2YUV conversion unit 165 for RGB video output.

The control unit 620 enables programmable management of the screen display area and position as well as other display parameters. The window management unit 630 is used to define the area of display and the position of the composite video layer on the display screen. The window management unit 630 sets the horizontal and vertical delay of the video output.

The synchro detection unit 640 uses the video HSync,VSync and the pixel clock signals and synchronizes the window management unit 630 and the output of the pixel data via the video data generation 650. The video data generation 650 produces a proper, synchronized video output.

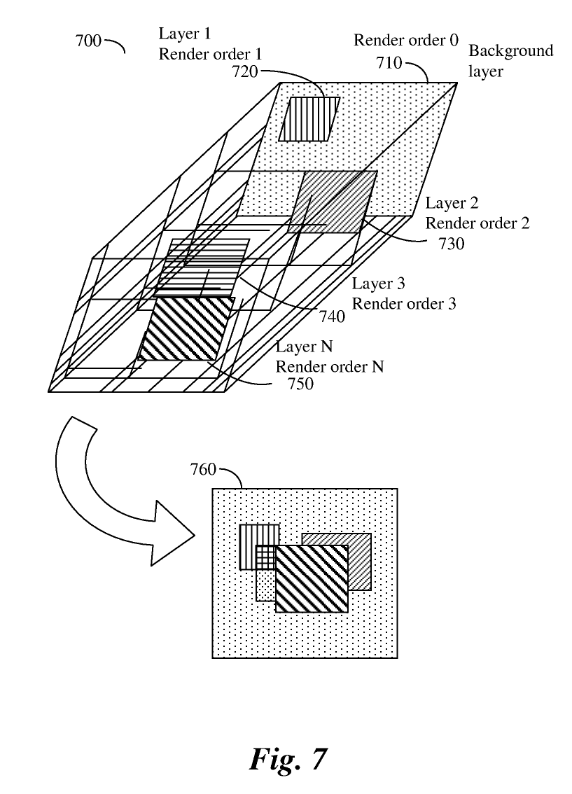

Reference is now made to FIG. 7, which shows an exemplary and non-limiting schematic diagram 700 of the alpha blending of multiple image layers and the rendering order in blending. The rendering order for each layer is configurable, from background layer 710, including layer 1 720, layer 2 730, layer 3 740 through layer N 750. The generic Alpha blending module 110 uses the rendering order for each layer in determining precedence for overlapping the composited layers. The rendering order for each layer is configurable (programmable), and can be modified at any time. The composited output video layer according to this example rendering order is shown in 760.

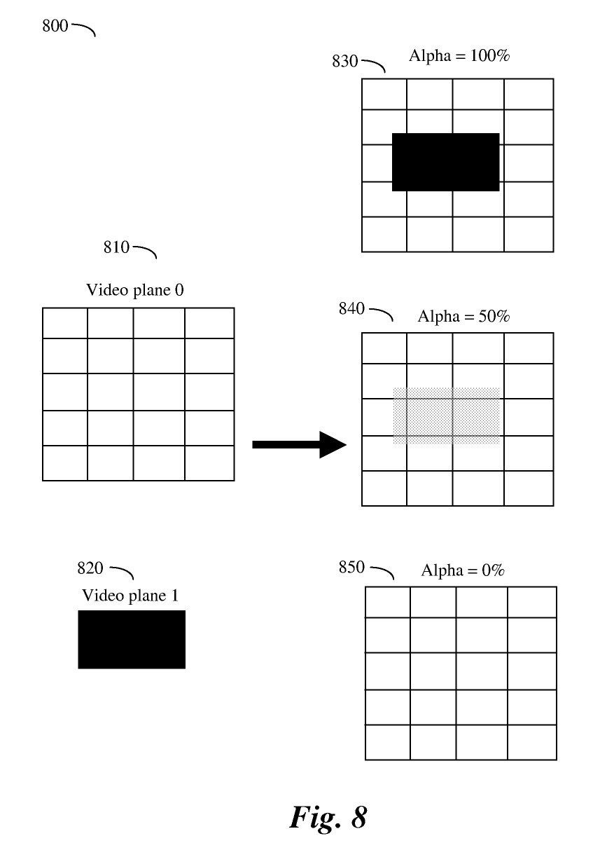

Reference is now made to FIG. 8 which shows an exemplary and non-limiting schematic diagram 800 of alpha blending of two layers. The blending is executed according to the alpha blending equation for each pixel:

Pr=αP1+(1−α)*P0

Where P0 is the pixel value from layer 0, P1 the pixel value from layer 1 and Pr is the output blended pixel. In the case of alpha=100% for the entire layer 1, layer 1 is fully opaque and occludes layer 0 as shown by 830. In the case of alpha=0% for the entire layer 1, layer 1 is fully transparent and only layer 0 is seen as shown by 850. In the case of alpha=50% for the entire layer 1, layer 1 is partially transparent as shown by 840.

With respect to FIG. 7, the foregoing alpha blending equation is applied when rendering layers are overlaid. By way of example, layer 720 having rendering order of 1 is alpha blended over the background layer 710, with layer 720 having an alpha value of 1 in the shaded area. Layer 2 730 having a rendering order of 2 is alpha blended over the result of the alpha blending of the background layer and layer 1, with Layer 2 having an alpha value of 1. Layer 3 740 having a rendering order of 3 is alpha blended over the result of the layer 2 blending operation, with layer 3 having an alpha value of 0.5. As shown in FIG. 7, layer 3 is partially transparent and partially overlays layer 1 and the background layer. Layer N 750 having a rendering order of N is the layer that is alpha blended over all the result of all alpha rendering operations. As shown in FIG. 7, Layer N having an alpha value of 1 is alpha blended over the alpha blending results. Layer N is opaque with respect to the previous results, and as shown in FIG. 7, overlaps the other layers. In the example shown in FIG. 7, there is a uniform alpha value for the entire layer. Since the alpha blending equation is applied at every pixel, a layer could have an alpha value for each pixel, such as a layer with a source in RGB Alpha format. In such a case, the transparency or opacity of the layer rendered over the underlying alpha blending results according to the rendering order is determined by the alpha value at each pixel.

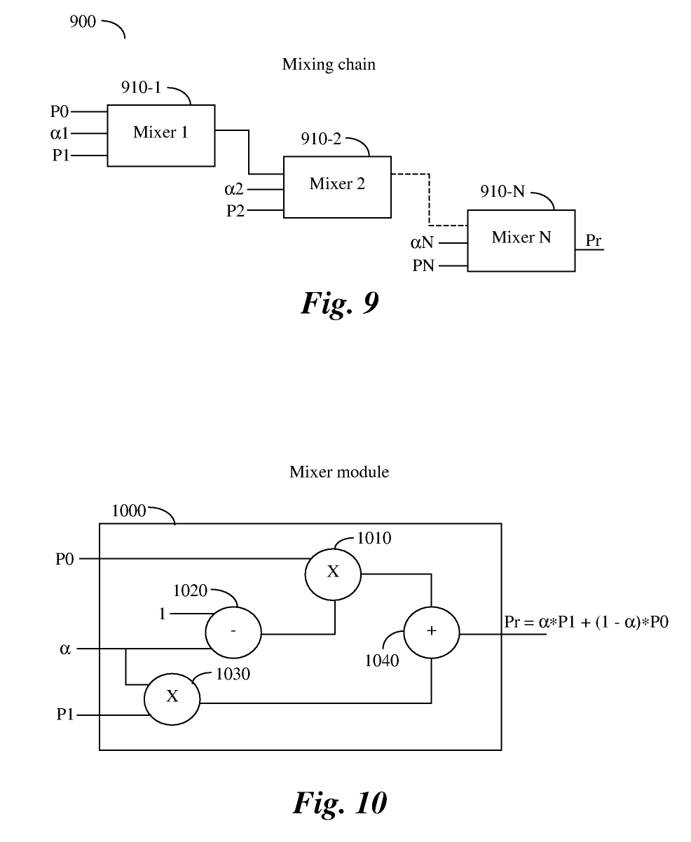

Reference is now made to FIG. 9, which shows an exemplary and non-limiting schematic diagram 900 of the implementation of alpha blending by the mixer unit chains in the pixel management module 230. The mixer chains implement the alpha blending of the plurality of video layers, the background layer and the sprite layers. The schematic diagram shows an exemplary and non-limiting portion of the mixer chain, with mixer units 910-1, 910-2, and continuing for N layers to mixer unit 910-N.

Mixer unit 910-1 receives the pixel value of layer of order 0, the pixel value of layer of order 1 and the alpha coefficient of layer of order 1 as input, and produces the alpha blended output. Mixer unit 910-2 receives the output of mixer 910-1, the pixel value of layer of order 2 and the alpha coefficient of layer of order 2, and produces the alpha blended output. The chain is repeated for N layers using N mixing units 910, where the N^{th} layer is mixed by unit 910-N, which receives the output of the N-1 mixing unit, the pixel value of layer N and the alpha coefficient of layer N.

Reference is now made to FIG. 10, which is an exemplary and non-limiting schematic diagram 1000 of an implementation of a representative one of the plurality of mixer modules for alpha blending, 910-1. The mixer module 910-1 receives the inputs of a background layer Pixel P0, a foreground layer pixel P1 and an alpha coefficient α. The mixer produces the output pixel Pr using the equation:

Pr=αP1+(1−α)P0

The module implements this function using multipliers 1010 and 1030, adder 1040 and subtraction unit 1020. The module computes the pixel α arithmetic using 32-bit RGB alpha format pixels.

Thus the processor described herein is operative using external memory solely for receiving the video input and for storage of the blended output video.

While the disclosed invention is described hereinabove with respect to specific exemplary embodiments, it is noted that other implementations are possible that provide the advantages described hereinabove, and which do not depart from the spirit of the inventions disclosed herein. Such embodiments are specifically included as part of this invention disclosure which should be limited only by the scope of its claims. Furthermore, the apparatus disclosed in the invention may be implemented as a semiconductor device on a monolithic semiconductor.

What is claimed is:

1. An apparatus for image processing comprising:
a plurality of pipelined format conversion modules, each for receiving a video input for a separate video layer in one of a plurality of video formats and converting the format of said video input to a first output format;
an alpha blending module coupled to said plurality of format conversion modules, said alpha blending module enabled for alpha blending of each of said separate video layers in parallel into a single blended output video in said first output format; and,
a control module coupled to said plurality of format conversion modules, the outputs of the plurality of pipelined format conversion modules and said alpha blending module;
said plurality of format conversion modules all being operative in parallel under control of said control module.

2. The apparatus of claim 1, further comprising:
a background layer module operative to provide a separate background video layer output in said first output format;
said alpha blending module also being coupled to said background layer module, said alpha blending module being enabled for alpha blending of each of said separate video layers into a single blended output video in said first output format.

3. The apparatus of claim 1, further comprising:
one or more sprite modules, each of said sprite modules enabled to output an image in said first output format, said one or more sprite modules also being coupled to said alpha blending module and further operative under control of said control module.

4. The apparatus of claim 3, wherein said sprite modules include a memory for storage of one or more sprites as graphics.

5. The apparatus of claim 1, wherein said apparatus is a monolithic semiconductor, and is operative using external memory solely for receiving said video input and for storage of said blended output video.

6. The apparatus of claim 1, wherein the single blended output video in said first output format is buffered in said monolithic semiconductor memory in a FIFO memory, providing read access to the single blended output video in said first output format.

7. The apparatus of claim 1, wherein said plurality of pipelined format conversion modules are synchronized responsive of video output requests.

8. The apparatus of claim 1, further comprising:
a video output module coupled to said alpha blending module, said video output module synchronized to said pipelined format conversion modules, a horizontal video synchronization signal and a vertical video synchronization signal.

9. The apparatus of claim 8, wherein said video output module is enabled to output for display, video output in one of: RGB format, YUV format.

10. The apparatus of claim 1, wherein at least one of said plurality of pipelined format conversion modules is enabled for conversion of YUV video format to RGB video format.

11. The apparatus of claim 1, further comprising:
a scaling module coupled between one of said plurality of pipelined format conversion modules and said alpha blending module, said scaling module coupled to receive a video input in said first output format and output a scaled video output in said first output format under control of said control module.

12. The apparatus of claim 1, wherein said control module is enabled to cause execution of alpha blending of a plurality of layers received from at least said plurality of pipelined format conversion modules such that rendering order of each layer is programmable.

13. The apparatus of claim 1, wherein said apparatus is enabled to provide a single blended output video to a memory.

14. The apparatus of claim 1, wherein said alpha blending module comprises:
a plurality of mixing circuits, each for executing alpha blending on a pair of video layers;
said plurality of a mixing circuits being connected in a chain such that an output of one mixing circuit in said plurality of mixing circuits is coupled to provide one of the pair of video layers to an immediately subsequent mixing circuit.

15. The apparatus of claim 1, comprising a system-on-chip implemented as a monolithic semiconductor device.

16. A method for blending a plurality of video input streams comprising:
receiving a plurality of video streams, each video stream being input to a respective pipelined format conversion module;
performing in parallel, format conversion of each of said plurality of video streams on said respective pipelined format conversion module, said format conversion comprising conversion from any video format into a first video format, resulting in a plurality of converted video streams each in said first video format; and
blending said plurality of converted video streams received from each of said respective pipelined format conversion modules using alpha blending, and outputting a blended output video in said first video format.

17. The method of claim 16, further comprising:
performing in parallel to said format conversion at least one sprite layer conversion into said first video format in a respective sprite layer module; and,
wherein said blending of said plurality of converted video streams further includes blending an output of said respective sprite layer module with said plurality of video streams.

18. A module for alpha blending of a plurality of input video layers into a single video output comprising:
a plurality of mixing circuits, each said mixing circuit for executing alpha blending on a pair of video layers;
said plurality of a mixing circuits being connected in a chain such that an output of one mixing circuit in said plurality of mixing circuits is coupled so as to provide one of the pair of video layers to an immediately subsequent mixing circuit.

19. An apparatus for image processing comprising:
a monolithic semiconductor having;
a plurality of pipelined format conversion modules, each for receiving a video input for a separate video layer in one of a plurality of video formats and converting the format of said video input to a first output format;
an alpha blending module coupled to said plurality of format conversion modules, said alpha blending module enabled for alpha blending of each of said separate video layers into a single blended output video in said first output format;
a FIFO coupled to the alpha blending module for buffering the single blended output video in said first output format and,
a control module coupled to said plurality of format conversion modules, the outputs of the plurality of pipelined format conversion modules and said alpha blending module;
said plurality of format conversion modules all being operative in parallel under control of and in synchronization by said control module responsive to video requests.

20. The apparatus of claim 19, further comprising:
a background layer module operative to provide a separate background video layer output in said first output format;
said alpha blending module also being coupled to said background layer module, said alpha blending module being enabled for alpha blending of each of said separate video layers into a single blended output video in said first output format.

21. The apparatus of claim 19, further comprising:
one or more sprite modules, each of said sprite modules enabled to output an image in said first output format, said one or more sprite modules also being coupled to said alpha blending module and further operative under control of said control module.

22. The apparatus of claim 19, wherein said apparatus is a monolithic semiconductor, and is operative using external memory solely for receiving said video input and for storage of said blended output video.

23. The apparatus of claim 19, further comprising:
a scaling module coupled between one of said plurality of pipelined format conversion modules and said alpha blending module, said scaling module coupled to receive a video input in said first output format and output a scaled video output in said first output format under control of said control module.

24. The apparatus of claim 19, wherein said apparatus is enabled to provide a single blended output video to a memory.
